(19) United States
(12) Patent Application Publication
(10) Pub. No.: US 2011/0057954 A1
(43) Pub. Date: Mar. 10, 2011

(54) IMAGE PROCESSING APPARATUS, METHOD, PROGRAM AND RECORDING MEDIUM FOR THE PROGRAM

(75) Inventors: Daisuke KOBAYASHI, Kanagawa (JP); Kei YAMAJI, Kanagawa (JP)

(73) Assignee: FUJIFILM CORPORATION, Tokyo (JP)

(21) Appl. No.: 12/555,993

(22) Filed: Sep. 9, 2009

(30) Foreign Application Priority Data
Sep. 9, 2009 (JP) 2008-230570

(51) Int. Cl. G06K 9/46; G09G 5/00

(52) U.S. Cl. 345/647; 382/195

(57) ABSTRACT

Generation of a 3D model in accordance with a user's desire is enabled. A model generation unit generates 2D or 3D model parts from extracted original parts. These model parts have been applied with relative exaggeration relative to another subject person or a background. If the user has selected a subject person of which a default part is modified, among subject persons of which the original parts have been extracted, via an operation unit, a model adjustment unit accepts selection of a modification menu item and a part desired to be modified, via the operation unit. If the part desired to be modified is selected, the part is modified or replaced depending on the selected menu item and on an input to the operation unit or a touch panel. A character generation unit generates a character with the modified part (with the default part if no modification is performed).

### BACKGROUND OF THE INVENTION

1. Field of the Invention

The present invention relates to a technique for generating a character from a subject person in an image.

2. Description of the Related Art

Japanese Patent Application Laid-Open No. 2008-102972 is an automatic 3D modeling system and a method thereof in which a 3D model can be generated from a photograph or another image. For example, the 3D model of a person's face can be automatically generated.

In Japanese Patent Application Laid-Open No. 2002-342789, an image processing unit synthesizes a head image generated by detecting an orientation, a position and a size of a target object in an image inputted by a user input unit generating a full-faced image of a previously-defined size, and rendering a three-dimensional model of a face rotated in a designated direction with the full-faced image as a texture image, and a previously drawn body image or a body image which can be easily generated from vector data for generating the body image, and thereby generates a three-dimensional character image with a small amount of calculation in which a three-dimensional calculation is limited only to the head.

Japanese Patent Application Laid-Open No. 2007-272435 discloses a technique for extracting a facial part from a CCD camera or a CMOS camera, or face image data which has been already taken. Japanese Patent Application Laid-Open No. 2008-158679 discloses a technique for obtaining a physical feature (a body height) other than a face image of a target person, based on an image. Japanese Patent Application Laid-Open No. 11-177835 discloses a technique for finishing a skin color and a sky color with relatively preferable brightness. Japanese Patent Application Laid-Open No. 2006-119817 discloses a technique for extracting a shaded background region and a non-shaded background region.

In “Kaochara”, retrieved on Aug. 13, 2008 from the Internet: URL [http://kaochara.jp/], eyes, eyebrows, a nose and a mouth are automatically recognized from a photograph, planar image parts having sizes or shapes similar to the sizes or the shapes of recognized parts are automatically selected, and a character image is generated. The image parts have been previously prepared on a system side.

In “Gizmoz”, retrieved on Aug. 13, 2008 from the Internet: URL [http://www.gizmoz.com/], 3D face photographs with various facial expressions are generated from a face photograph.

In “Generation of Three-Dimensional Portrait Also with Exaggerated Color”, retrieved on Aug. 13, 2008 from the Internet: URL [http://chihara.aist-nara.ac.jp/gakkai/VIR/PDF/A-16.pdf], shapes of facial parts (both eyebrows, both eyes, a nose and a mouth), an arrangement of the facial parts, and a face color of a model are emphasized in a three-dimensional portrait. Exaggeration of the color makes a suntanned person appear to be more deeply suntanned.

### SUMMARY OF THE INVENTION

In the conventional systems, although the 3D model can be generated based on the image, a user's own free will cannot be reflected. As a result, the user cannot generate the 3D model according to the user's wishes.

It is an object of the present invention to enable generation of a 3D model in accordance with a user's mental image.

An image processing apparatus according to an aspect of the present invention comprises: an input unit which inputs an image; a part extraction unit which extracts a part of a desired first subject person from the image inputted by the input unit; a model part generation unit which generates a model part corresponding to the first subject person, based on the part extracted by the part extraction unit; and an exaggeration unit which relatively exaggerates an attribute of the model part depending on a difference between an attribute included in the image other than an attribute of the first subject person, and the attribute of the first subject person.

Preferably, the part extraction unit extracts a part of a second subject person that is included in the image and is different from the first subject person, and the exaggeration unit relatively exaggerates an attribute of the part of the first subject person depending on a difference between an attribute of the part of the second subject person and the attribute of the part of the first subject person.

Preferably, the exaggeration unit relatively exaggerates the attribute of the part of the first subject person depending on a difference between an attribute of a background included in the image and the attribute of the part of the first subject person.

Preferably, the image processing apparatus according to the present invention further comprises a motion detection unit which detects a user's motion, and a part adjustment unit which replaces or changes the part of the first subject person or the attribute of the part, based on the user's motion detected by the motion detection unit.

Preferably, the attribute includes at least one of a shape, a color and a position.

Preferably, the image processing apparatus according to the present invention further includes a character generation unit which generates a character based on the model part of the first subject person.

Preferably, the model part generation unit changes a precision of the model part depending on a size of the first subject person.

In an image processing method according to another aspect of the present invention, a computer executes the steps of: inputting an image; extracting a part of a desired first subject person from the inputted image; generating a model part corresponding to the first subject person, based on the extracted part; and relatively exaggerating an attribute of the model part depending on a difference between an attribute included in the image other than an attribute of the first subject person, and the attribute of the first subject person.

The present invention also provides an image processing program which causes a computer to execute the above-stated image processing method.

The present invention also provides a recording medium in which computer readable code of the above-stated image processing program is stored.

In the present invention, the model part is generated based on the part of the first subject person extracted from the image, and the part is relatively emphasized and set as a default part. Hence, the default part to be exaggerated is different depending on another person existing together in the image or on the background, and there is a clear difference between a stranger existing together in the image or the background and the character of the first subject person.

### BRIEF DESCRIPTION OF THE DRAWINGS

FIG. 1 is a block diagram of an image processing apparatus;

FIG. 2 is a diagram showing an example of parts extracted from an image;

FIG. 3 is a diagram showing features of the parts of each subject person;

FIGS. 4A and 4B are diagrams showing an example of an image in which the subject person is large, and an example of an image in which the subject person is small, respectively;

FIG. 5 is a diagram showing an example of exaggerated parts;

FIG. 6 is a diagram showing an example of a model part adjustment screen;

FIG. 7 is a diagram showing an example of a degree of mouth opening which has been exaggerated in a step-by-step manner;

FIG. 8 is a diagram showing an example of a lip thickness which has been exaggerated in a step-by-step manner;

FIG. 9 is a diagram showing a situation where a size of a mouth part is changed to be larger in response to a motion sensed by an operation unit;

FIG. 10 is a diagram showing a situation where the size of the mouth part is changed to be smaller in response to the motion sensed by the operation unit;

FIG. 11 is a diagram showing an example of a drawn part;

FIG. 12 is a diagram showing a situation where a shape of the mouth part is changed in response to the motion sensed by the operation unit;

FIG. 13 is a diagram showing a situation where a color of a face is changed in response to the motion sensed by the operation unit; and

FIG. 14 is a flowchart of a character generation process.

### DETAILED DESCRIPTION OF THE PREFERRED EMBODIMENTS

### First Embodiment

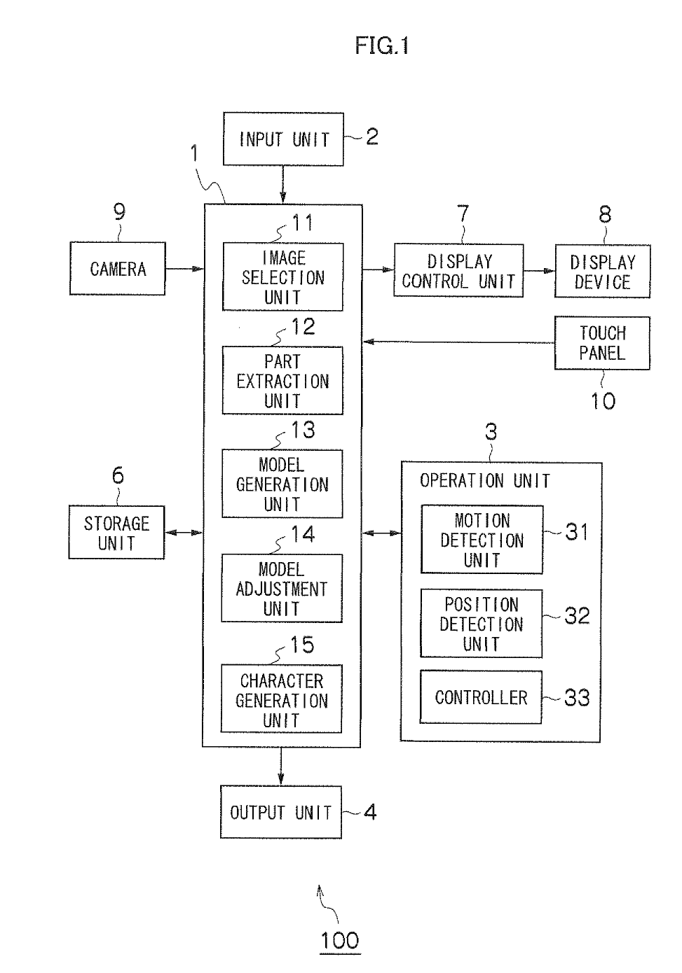

FIG. 1 is a functional block diagram of an image processing apparatus 100 according to a preferred embodiment of the present invention. First, in a central processing unit (CPU) 1, an operation unit 3 detects inputs from various buttons or keys of the operation unit 3, or various motions applied to the operation unit 3, for example, motions such as “lift up”, “lift down”, “shake”, “rotate”, “tilt”, “twist” and “hold”, in real time, and based on the detected motions, respective circuits in the image processing apparatus 100 are controlled in an integrated manner. Programs executed by the CPU 1 are stored in a ROM of a storage unit 6.

An input unit 2 is a device which inputs information on image data and the like from external storage media which are electronically connected (a memory card, a CDR, a DVD and the like), or various electronic devices (a digital camera, a personal computer, a cellular phone and the like), and includes, for example, a USB port, a media reader, a network adapter and the like.

The inputted image data (including a still image, a moving image, and each frame image constituting the moving image, and the same applies to the followings) is processed by the CPU 1. Once the processed image data is stored in a RAM of the storage unit 6, the image is outputted to a display control unit 7. The display control unit 7 is a video encoder, which converts an inputted YC image signal into a signal of a predetermined system for display (for example, a color composite video signal of an NTSC system), and outputs the signal to a display device 8 such as a display.

An output unit 4 is a device which outputs the image data processed by the CPU 1 to the external storage media which are electronically connected (the memory card, the CDR, the DVD and the like), or the electronic devices (a printer, the personal computer, the cellular phone and the like), and includes, for example, the USB port, the media reader, the network adapter and the like. In a broad sense, the output unit 4 also includes the display device 8.

A camera 9 takes an image of a body portion desired by a user. The camera 9 includes an image pickup lens, an image pickup element such as a CCD or a CMOS, an image processing circuit and the like. Generated image data is stored in the storage unit 6. This image is used for recognition of the body portion by the CPU 1.

On the display device 8, a touch panel 10 is laminated. When the user depresses a corresponding portion on the display device 8 by the user's finger or a pen, information indicating the depressed position is outputted to the CPU 1. The CPU 1 detects a trajectory of a depressed position obtained by successively changing the depressed position, and thereby a drawn line can be inputted.

The operation unit 3 has a motion detection unit 31, a position detection unit 32 and a controller 33, which are contained in a case of a form which is preferably portable for the user. The motion detection unit 31 detects the various motions accumulated in the operation unit 3, for example, the motions such as “lift up”, “lift down”, “shake”, “rotate”, “tilt”, “twist” and “hold” (hereinafter referred to as “dynamic operations”) as instruction input operations in real time, and outputs the dynamic operations to the CPU 1. Specifically, the motion detection unit includes an acceleration sensor 701 of three axes (X, Y and Z axes), a rotation sensor which detects an angular velocity and an angular acceleration of an azimuth angle and an elevation angle, and a pressure sensor which detects a pressure applied to an outer package of the operation unit 3 being held. A player's motion is detected in an arbitrary cycle. In a shorter cycle, accordingly, instantaneous motions can be successively observed. Moreover, the motion detection unit 31 includes a temperature sensor, and can also detect a temperature of a user's hand holding the operation unit 3.

The position detection unit 32 is a device with which the player detects a designated position on a screen displayed on the display device 8. The position detection unit 32 includes a CMOS sensor or the like. Position information transmitted from the position detection unit 32 to the CPU 1 is represented, for example, in two or more dimensional coordinates in a real space set on the screen of the display device 8. Successive designation of the position can designate a trajectory of a motion.

A controller 33 includes a circuit which senses depression of operating members such as the buttons or the keys.

Processing units executed by the CPU 1 include an image selection unit 11, a part extraction unit 12, a model generation unit 13, a 3D model adjustment unit 14, and a character generation unit 15. These units have been stored as programs in the ROM of the storage unit 6, and are loaded into the RAM and executed by the CPU 1.

The image selection unit 11 selects a desired image from the images inputted via the input unit 2, in response to an instruction from the controller 33 of the operation unit 3.

The part extraction unit 12 extracts parts of a subject person and features of the parts from the image selected by the image selection unit 11. In other words, first, the part extraction unit 12 extracts original parts (eyebrows, eyes, a nose, a mouth, ears, hair and the like) of a person's face image. This extraction can be performed by a known technique, for example, a technique described in Japanese Patent Application Laid-Open No. 2007-272435. If a plurality of face regions of persons exist in the selected image, the part extraction may be performed only in a face region selected by the operation unit 3, or the part extraction may be performed in all the face regions. The part extraction unit 12 also extracts physical features other than the face, corresponding to each face image. This extraction can be performed by using a known technique, for example, a technique described in Japanese Patent Application Laid-Open No. 2008-158679. The physical features other than the face image include a body height, and in addition, constituent elements of the subject person such as a facial contour, a hairstyle, a body type and the like.

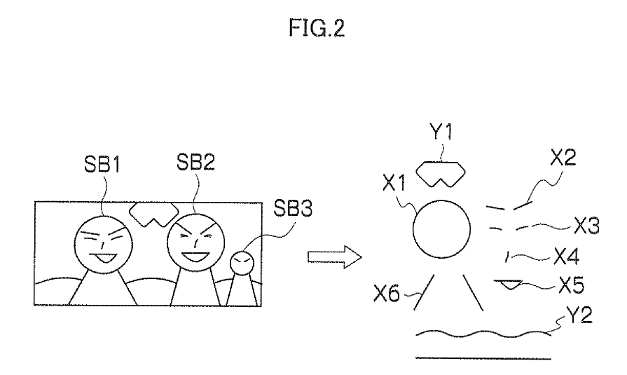

FIG. 2 shows an example of the original parts of the subject person and background parts, which have been extracted from the image by the part extraction unit 12. Here, from an image I in which three persons SB1, SB2 and SB3 exist, a facial contour X1, both eyebrows X2, both eyes X3, a nose X4, a mouth X5 and a body X6 of the person SB1, as well as a cloud Y1 and a mountain Y2 included in a background have been extracted. Although not shown, the part extraction can also be similarly performed for SB2 and SB3.

The part extraction unit 12 recognizes the features of the extracted parts, and stores the features separately for each subject person in the storage unit 6.

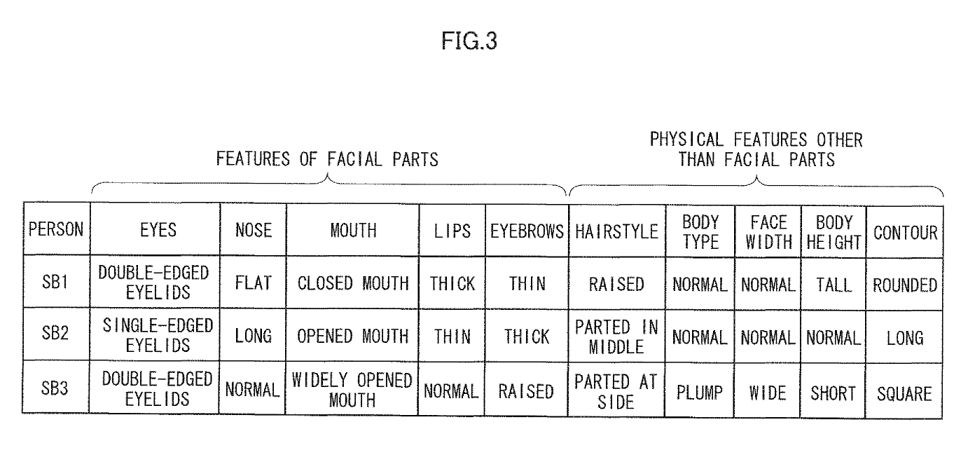

FIG. 3 shows an example of a personal feature table in which the features corresponding to the original parts of the subject persons extracted by the part extraction unit 12 have been stored. The personal feature table is stored in the RAM of the storage unit 6.

Moreover, the part extraction unit 12 extracts the background parts which are constituent elements of a scene of the taken image, other than the persons. In this extraction, a known technique, for example, a technique described in Japanese Patent Application Laid-Open No. 2006-119817 is used to extract a background region, and subsequently, edge components existing in the background region are detected, and regions surrounded by the edge components are recognized as the background parts. Then, the part extraction unit 12 extracts features (a color, an area, an object type and the like) of the entire background or individual background parts, and stores the features in the RAM of the storage unit 6.

The model generation unit 13 generates 2D or 3D model parts based on the original parts extracted by the part extraction unit 12. The 2D or 3D parts can be generated by a known technique, for example, a technique described in “Gizmoz”, retrieved on Aug. 13, 2008 from the Internet: URL [http://www.gizmoz.com/]. It is assumed that data required for generating the model parts (image data of the eyes/nose/mouth/body of large/medium/small sizes and the like) has been stored in the storage unit 6.

If the plurality of face regions of the subject persons exist in the selected image, the model generation unit 13 determines one face region of the subject person of which the original parts are extracted, and of which a character should be generated based on the parts, in response to the operation on the operation unit 3, or randomly. The person of which the original parts are extracted and of which the character is generated is referred to as “target person”, and the face region of the target person is referred to as “target face region”. Moreover, the subject person other than the target person is referred to as “non-target person”, and the face region of the non-target person is referred to as “non-target face region”.

First, the model generation unit 13 extracts facial parts from both the target face region and the non-target face region. Then, facial model parts corresponding to original facial parts in the target face region are generated.

Next, depending on a result of comparison between the facial parts in the target face region and the facial parts in the non-target face region, the model generation unit 13 relatively exaggerates the above generated model facial parts corresponding to the original facial parts in the target face region. In other words, depending on a relative amount of a feature amount of the original facial part in the target face region to a feature amount of the original facial part in the non-target face region, the model part corresponding to the facial part in the target face region is exaggerated. This exaggeration is performed for each type of the facial parts (the eyes, the nose, the mouth and the like). In this way, all the types of the facial parts in the target face region are exaggerated, and a default exaggerated 3D model (or a default exaggerated 2D model) is generated by using respective obtained model parts. When an individual face vector of the target face region (attributes such as a shape, a color and a part arrangement position correspond to vector elements) is P1, an individual face vector of the non-target face region is P2, “a” is an exaggeration ratio, and P′ is an individual face vector which is a base of the default exaggerated 3D model (a polygon on which a texture is pasted), this exaggeration is represented as P′=P1+a(P1−P2). “a” is a numerical value larger than 0, and has been previously stored in the ROM of the storage unit 6. The texture (two-dimensional image data) of the face portion is pasted based on P′, and thereby the default exaggerated 3D model is completed.

Also for the physical features other than the face, similarly to the facial parts, depending on a relative amount of a feature amount of the physical feature of the original part corresponding to the target face region to a feature amount of the physical feature of the person corresponding to the non-target face region, the physical feature of the model part corresponding to the target face region is exaggerated. For example, if the hair of the person corresponding to the target face region is longer than a body height/shoulder width/abdominal width/hair/neck length/lip thickness corresponding to the non-target face region, the body height/shoulder width/abdominal width/hair/neck length/lip thickness of the person corresponding to the target face region is further lengthened. Conversely, if the body height/shoulder width/abdominal width/hair/neck length/lip thickness of the person corresponding to the target face region is shorter than the body height/shoulder width/abdominal width/hair/neck length/lip thickness corresponding to the non-target face region, the body height/shoulder width/abdominal width/hair/neck length/lip thickness of the person corresponding to the target face region is further shortened. If a skin color of the person corresponding to the target face region is whiter or darker than the skin color of the person corresponding to the non-target face region, the skin color of the person corresponding to the target face region is further whiten or darken.

Alternatively, angles of the eyebrows may be increased to emphasize raised eyebrows, rising of a parting portion of the hair parted at the side may be increased and emphasized, or areas of the eyebrows, areas of pupils or areas of folds of eyelids may be increased or the like.

“Exaggerate” includes not only changing a value in a direction of increase or intensification, but also changing the value in a direction of decrease or restraint. For example, in FIG. 2, it is assumed that the face region of the subject SB2 includes a wrinkle component with an amplitude of wrinkles, flecks, noises or the like smaller than that of the face region of the subject SB1. In this case, like a known skin beautifying process, an amplitude of a frequency band of the wrinkle component of the subject SB1 can be reduced so that the subject SB1 appears to have a more beautiful skin than the subject SB2.

In this way, the physical feature amount indicating a relative difference between the person in the target face region and the person in the non-target face region is further exaggerated in the model parts. This is represented by a general equation as follows. If a vector of the physical features of the person in the target face region (the attributes such as the shape, the color and the part arrangement position of the face or the parts other than the face correspond to the vector elements) is R1, a vector of the physical features of the person in the non-target face region is R2, b is the exaggeration ratio, and R′ is the individual face vector of the default exaggerated 3D model, R′=R1+b(R1−R2). Here, b is an arbitrary numerical value larger than 0, and has been previously stored in the ROM of the storage unit 6. If there are non-target regions of two or more persons, an average of the physical features thereof M(R) may be substituted for R2 in the above described equation. In other words, the above described equation may be R′=R1+b(R1−M(R)). According to this equation, in the physical features of the person in the target face region, a portion which is different from average physical features of other persons is emphasized. The texture (two-dimensional image data) of the body portion other than the face is pasted based on R′, and thereby the default exaggerated 3D model is completed.

It should be noted that, at paragraph 2.4.1 of “Generation of Three-Dimensional Portrait Also with Exaggerated Color”, retrieved on Aug. 13, 2008 from the Internet: URL [http://chihara.aist-nara.ac.jp/gakkai/VIR/PDF/A-16.pdf], a reference for the exaggeration is an average face vector. In other words, if the individual face vector of the target face region is the same as the average face vector, nothing is exaggerated. In the embodiment of the present application, the reference for the exaggeration is not the average face vector, but is the individual face vector of the non-target face region. In other words, if the individual face vector of the target face region is the same as the individual face vector of the non-target face region, nothing is exaggerated. The embodiment of the present application is characterized in that, if complete strangers exist together in the same image, the target person is relatively exaggerated based on a difference between the features of the facial parts of both persons, and a portion to be exaggerated is different depending on the non-target person existing together in the image. In an extreme case, if identical twins exist together in the same image, no model part would be exaggerated.

If there are not multiple persons in the same image, feature amounts obtained from a surrounding background are compared with the feature amounts of the person, and a portion indicating a relatively large difference between the feature amounts thereof is exaggerated. For example, if the background part is a blue sky and the person part is the skin color, a known technique such as Japanese Patent Application Laid-Open No. 11-177835 is used to emphasize the skin color relative to the blue sky.

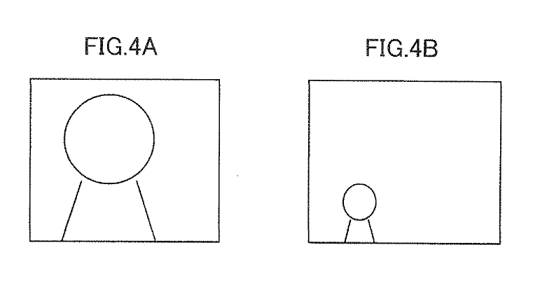

The model generation unit 13 may change a level of detail of the model parts to be generated, depending on a size of the target person. For example, detailed model parts are assigned to a target person who is large in the image as shown in FIG. 4A, and simple model parts are assigned to a target person who is small in the image as shown in FIG. 4B. The detailed model parts are assumed to have a larger number of feature points sampled from the original parts, than the simple model parts. This prevents the model generation unit 13 from attempting to generate unsuitably detailed model parts for the small person of which detailed features cannot be perceived in the image, which improves processing efficiency.

FIG. 5 shows an example of the original parts of the target person which have been extracted by the part extraction unit 12, default model parts generated by the model generation unit 13 based on the original parts, and the default model parts which have been relatively exaggerated at a predetermined exaggeration ratio.

The model adjustment unit 14 varies the exaggeration ratio “a” for the feature of each model part in the default model parts generated by the model generation unit 13, in response to the dynamic operation on the operation unit 3. The feature of the facial part can be exaggerated by a known technique such as “Generation of Three-Dimensional Portrait Also with Exaggerated Color”, retrieved on Aug. 13, 2008 from the Internet: URL [http://chihara.aist-nara.ac.jp/gakkai/VIR/PDF/A-16.pdf]. However, the embodiment of the present application is characterized in that a degree of the exaggeration can be changed by the dynamic operation on the operation unit 3.

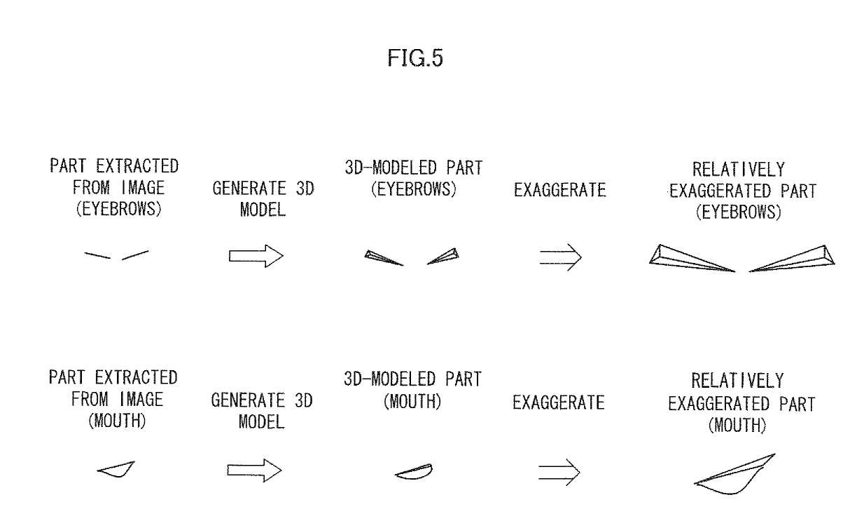

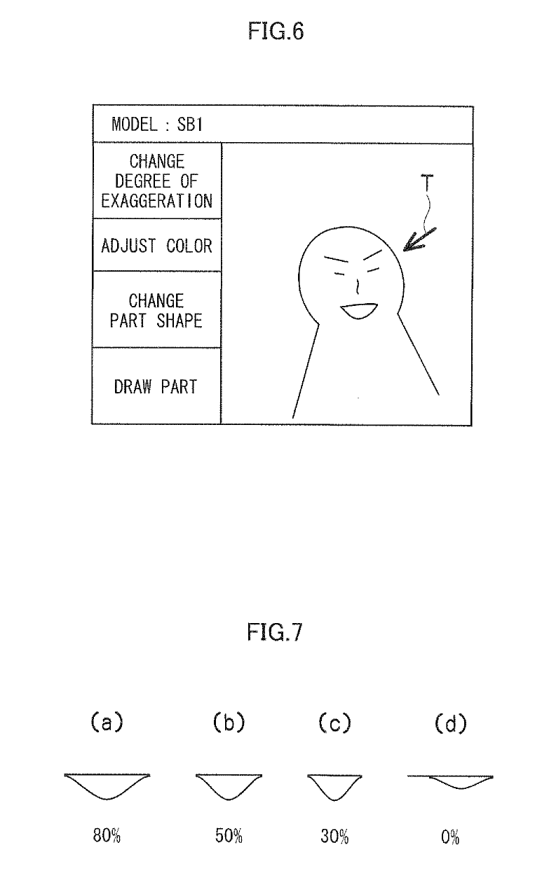

For example, as shown in FIG. 6, the model adjustment unit 14 instructs the display control unit 7 to generate a model part adjustment screen on which adjustment of the default model parts generated by the model generation unit 13 is performed. In a side portion on the model part adjustment screen, modification menu items of “Change Degree of Exaggeration”, “Adjust Color”, “Change Part Shape” and “Draw Part” are displayed. In the center of the screen, a default character which imitates the person by using the default model parts generated by the model generation unit 13 is displayed. The default character is generated by the character generation unit 15. When a particular motion such as moving a pointer T to a desired menu item via the operation unit 3 and depressing the button of the controller 33 at that location is performed, the CPU 1 accepts selection of the menu item.

The model adjustment unit 14 changes the shape, the color and the degree of exaggeration of the default model part in response to the operation from the operation unit 3, or performs drawing of a model part and replaces a designated default model part with a completely drawn model part in response to the operation from the operation unit 3.

In response to the position detection unit 32 of the operation unit 3 detecting the menu item of “Change Degree of Exaggeration”, the model adjustment unit 14 moves to a process of “Change Degree of Exaggeration”. In other words, first, the model adjustment unit 14 accepts selection of a desired part of which the degree of exaggeration is desired to be changed, via the operation on the operation unit 3. The model adjustment unit 14 may recognize the body portion of which the image has been taken by the camera 9, and may select a part corresponding to the body portion. For example, if the model adjustment unit 14 recognizes that the image data obtained from the camera 9 includes a right eyebrow, a left eyebrow, a right eye, a left eye, the nose or the mouth, the model adjustment unit 14 recognizes the right eyebrow, the left eyebrow, the right eye, the left eye, the nose or the mouth as a part targeted for the change of the degree of exaggeration. The model adjustment unit 14 identifies a part existing at the position detected by the position detection unit 32 of the operation unit 3, as the part targeted for the change of the degree of exaggeration. Then, the model adjustment unit 14 exaggerates the identified part targeted for the change of the degree of exaggeration, in a step-by-step manner, and instructs the display control unit 7 to display each step-by-step exaggerated part in a list (or to sequentially switch and display each step-by-step exaggerated part).

FIG. 7 illustrates a list in which a degree of mouth opening of the default part of the mouth has been exaggerated in a step-by-step manner in a case where the default part of the mouth has been selected as the part targeted for the change of the degree of exaggeration. FIG. 7(a) shows a highest degree of exaggeration of 80%, FIG. 7(b) shows the degree of exaggeration of 50% which is a medium degree, FIG. 7(c) shows the degree of exaggeration of 30% which is lower than the medium degree, and FIG. 7(d) shows the degree of exaggeration of 0%, that is, the default part targeted for the change of the degree of exaggeration itself.

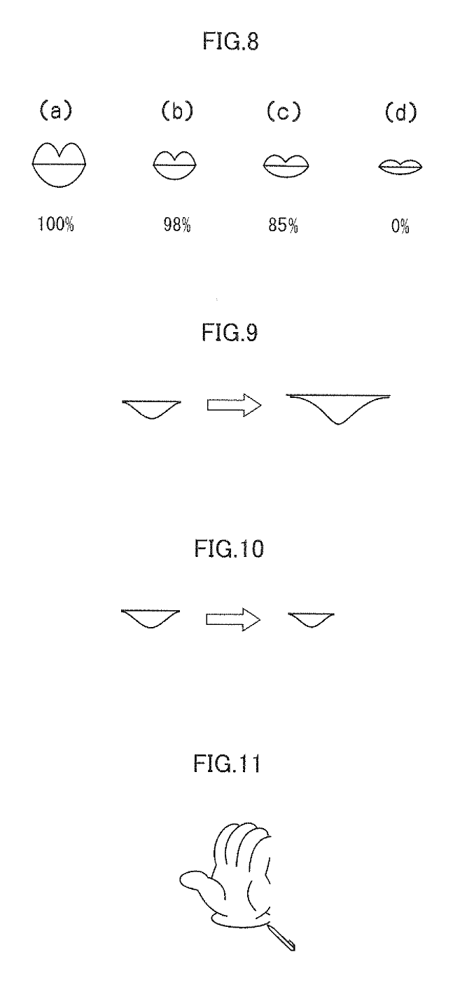

FIG. 8 illustrates a list in which the lip thickness of the default part of the mouth has been exaggerated in a step-by-step manner in a case where the default part of the mouth has been selected as the part targeted for the change of the degree of exaggeration. FIG. 8(a) shows the highest degree of exaggeration of 80%, FIG. 8(b) shows the degree of exaggeration of 50% which is the medium degree, FIG. 8(c) shows the degree of exaggeration of 30% which is lower than the medium degree, and FIG. 8(d) shows the degree of exaggeration of 0%, that is, the default part targeted for the change of the degree of exaggeration itself.

Like the degree of mouth opening and the lip thickness of the mouth as described above, if there are a plurality of parameters of which the degrees of exaggeration are desired to be changed even in the same part, the model adjustment unit 14 may cause the parameter of which the degree of exaggeration is desired to be changed, to be previously selected via the operation unit 3, and may change only the degree of exaggeration of the selected parameter in a step-by-step manner. Alternatively, the degree of mouth opening and the lip thickness of the mouth may be simultaneously changed.

The user selects the part with a desired degree of exaggeration from the step-by-step exaggerated parts via the operation unit 3. The model adjustment unit 14 replaces the default part targeted for the change of the degree of exaggeration with the part with the degree of exaggeration selected via the operation unit 3. The character generation unit 15 generates a new character in which the part has been replaced by the model adjustment unit 14, and outputs the new character to the display device 8. Thereby, the user can freely change the degree of exaggeration, and excessive exaggeration which does not satisfy the user's wishes or poor exaggeration which is almost characterless can be prevented.

Alternatively, instead of automatically changing the degree of exaggeration of the default part the degree of exaggeration may be changed in response to the operation on the operation unit 3. For example, if the motion detection unit 31 of the operation unit 3 has detected a motion of right rotation, the model adjustment unit 14 increases the degree of exaggeration, and if the motion detection unit 31 of the operation unit 3 has detected a motion or left rotation, the model adjustment unit 14 decreases the degree of exaggeration.

FIG. 9 illustrates a situation where the degree of mouth opening is increased in response to the operation unit 3 rotating to the right. FIG. 10 illustrates a situation where the degree of mouth opening is decreased in response to the operation unit 3 rotating to the left. The degree of exaggeration may be increased in response to the left rotation, and may be decreased in response to the right rotation. Moreover, the model adjustment unit 14 may increase the degree of exaggeration of the feature when the operation unit 3 is pushed forward, and may decrease the degree of exaggeration of the feature when the operation unit 3 is pulled backward, or the like. Moreover, which part among the respective parts such as the eyes, the nose and the mouth is changed, and which attribute among the attributes such as a thickness, a length and the color is changed in the degree of exaggeration may be previously selected via the controller 33, and the model adjustment unit 14 may change the degree of exaggeration of the selected attribute of the selected part depending on a detection result in the motion detection unit 31.

In response to the position detection unit 32 of the operation unit 3 detecting designation of the menu item of “Draw Part”, the model adjustment unit 14 moves to a process of “Draw Part”. In other words, first, the model adjustment unit 14 accepts selection of a desired part desired to be replaced (a part targeted for the replacement), via the operation on the operation unit 3. Next, the model adjustment unit 14 recognizes the trajectory of the depressed position designated from the touch panel 10 as a line, and converts plane coordinate information on this line into image data. Then, in response to “Terminate Drawing” being instructed by the operation unit 3, the model adjustment unit 14 replaces the selected part with the above described image data. The model adjustment unit 14 may display a color palette on the display device 8, cause a desired color of a designated desired region to be selected from the color palette via the operation unit 3, and color the designated region with the selected color.

In FIG. 11, a shape of a left hand is being inputted from the touch panel 10. The part targeted for the replacement of the left hand is replaced with the image data of this left hand. The model adjustment unit 14 may automatically recognize the part to be replaced, depending on the shape inputted from the touch panel 10. For example, if a transverse line forming an acute angle with respect to a horizontal line is inputted from the touch panel 10, the default part of the left eyebrow is replaced with drawing data thereof.

In response to the position detection unit 32 of the operation unit 3 detecting designation of the menu item of “Change Part Shape”, the model adjustment unit 14 moves to a process of “Change Part Shape”. In other words, first, the model adjustment unit 14 accepts selection of a desired part of which the shape is desired to be changed (a part to be changed), via the operation on the operation unit 3. Next, the model adjustment unit 14 changes the shape of the part to be changed, depending on the pressure (grip power) or the temperature applied to the operation unit 3, which has been detected by the motion detection unit 31 of the operation unit 3.

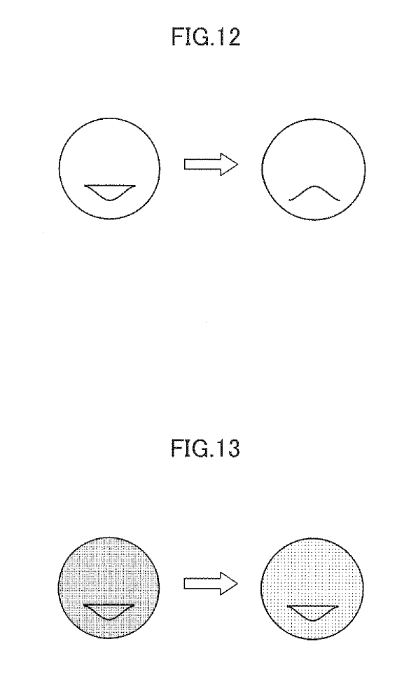

For example, as shown in FIG. 12, if the grip power equal to or larger than a predetermined threshold (for example, 10 kg) has been detected, the shape of the mouth which is the part to be changed is changed from a state of corners of the mouse being turned up (a state of a smiling look), to a state of the corners of the mouse being turned down (an angry look with the mouth turned down at the corners). Alternatively, if an increase in the temperature equal to or higher than a predetermined threshold (for example, 30 degrees) has been detected, the shape of the mouth is changed from the state of the corners of the mouse being turned up, to the state of the corners of the mouse being turned down. Conversely, if the pressure or the temperature has been detected to be decreased to the predetermined threshold, the shape of the mouth is changed from the state of the corners of the mouse being turned down, to the state of the corners of the mouse being turned up. In other words, the part shape is reversibly changed in response to the detection of the user's motion.

Alternatively, after the change of the part shape has been instructed by the controller 33, the change of the shape may be confirmed in response to the grip power being sensed.

In response to the position detection unit 32 of the operation unit 3 detecting designation of the menu item of “Adjust Color”, the model adjustment unit 14 moves to a process of “Adjust Color”. In other words, first, the model adjustment unit 14 accepts selection of a desired part desired to be applied with color adjustment (the part to be changed), via the operation on the operation unit 3. Next, the model adjustment unit 14 changes the color of the part to be changed, in response to the rotation operation on the operation unit 3, which has been detected by the motion detection unit 31 of the operation unit 3. For example, the model adjustment unit 14 changes colors of RGB in response to the rotation of the operation unit 3 to the left and the right (in the azimuth angle) or back and forth (in the elevation angle), or changes a contrast or a shadow value in response to up and down movement of the operation unit 3.

Particularly, in response to a case where the pressure or the temperature has been detected to be increased beyond or decreased below the predetermined threshold, if the color of the face region of the character is changed to red or blue, or if the corners of the mouse are turned up or down as described above, variation of the character in accordance with a force applied to the operation can be obtained, which provides more interesting entertainment.

The character generation unit 15 generates the character (an image representing the user, which may also be referred to as “avatar” or the like), based on the model part generated by the model generation unit 13, or based on the replaced/adjusted model part if the model adjustment unit 14 has replaced/adjusted the model part. This generation is performed, for example, by using the technique described in “Gizmoz”, retrieved on Aug. 13, 2008 from the Internet: URL [http://www.gizinoz.com/]. The character may be generated each time the model adjustment unit 14 replaces/adjusts the model part, or the character may be generated after the replacement/adjustment of all the model parts has been finished.

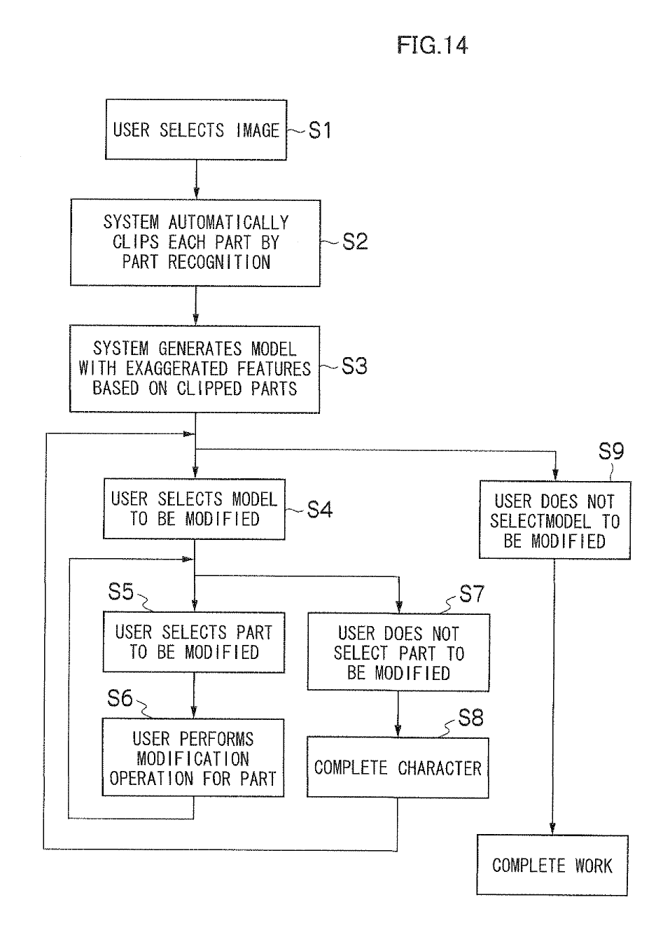

FIG. 14 shows a flowchart of a character generation process executed by the CPU 1.

In S1, the image selection unit 11 selects the desired image depending on contents of the detected operation on the operation unit 3, from the images inputted via the input unit 2.

In S2, the part extraction unit 12 extracts the original parts from the selected image.

In S3, the model generation unit 13 generates the 2D or 3D model parts from the extracted original parts. As described above, these model parts have been applied with the relative exaggeration.

If the user has selected the subject person of which the default part is modified, among the subject persons of which the original parts have been extracted, via the operation unit 3 (S4), the model adjustment unit 14 accepts the selection of the modification menu item and the part desired to be modified, via the operation unit 3. However, as described above, if the model adjustment unit 14 automatically recognizes the part to be replaced, depending on the shape inputted from the touch panel 10, the selection of the part desired to be modified is not required. If the part desired to be modified is selected (S5), the process proceeds to S6. If the selection of the modification menu item or the selection of the part desired to be modified is not performed (S7), the process proceeds to S8.

In S6, as described above, the part is modified or replaced depending on the selected menu item and on the input to the operation unit 3 or the touch panel 10.

In S8, the character is generated with the part modified in S6 (with the default part if no modification is performed).

If the user has not selected the subject person of which the default part is modified, among the subject persons of which the original parts have been extracted, via the operation unit 3 (S9), the character for the subject person is not generated, and the process is terminated.

As described above, in the embodiment of the present application, the model part is generated based on the part of the person extracted from the image, and the part is relatively emphasized and set as the default part. Hence, the default part to be exaggerated is different depending on the non-target person existing together in the image, and there is a clear difference between the character generated from the parts of the non-target person existing together in the image and the character generated from the parts of the target person. Moreover, in response to the operation inputted to the operation unit 3 or the touch panel, the part itself can be replaced, or the attribute of the part, particularly the exaggeration ratio, the shape or the color can be freely changed. Therefore, originality of the character is increased, and the user's intent can also be faithfully reflected.

### Second Embodiment

Instead of changing the attribute of the object to emphasize the object, the attribute of the image other than the attribute of the object to be emphasized may be changed to relatively exaggerate the object. For example, as shown in FIG. 2, it is assumed that multiple subjects SB1 and SB2 exist in the image, and a white color component of the face region of the subject SB1 has a higher intensity than that of the white color component of the face region of the subject SB2. In this case, instead of increasing the white color component of the face region of the subject SB1, a black color component of the face region of the subject SB2 is increased to relatively increase the white color component of the face region of the subject SB1 more than that of the subject SB2, and the subject SB1 appears to be more fair-skinned than the subject SB2.

Alternatively, it is assumed that the face region of the subject SB2 includes the wrinkle component with the amplitude of the wrinkles, the flecks, the noises or the like smaller than that of the face region of the subject SB1. In this case, the amplitude of the frequency band of the wrinkle component of the subject SB2 can be increased so that the subject SB1 appears to have the more beautiful skin than the subject SB2.

What is claimed is:

1. An image processing apparatus, comprising:
an input unit which inputs an image;
a part extraction unit which extracts a part of a desired first subject person from the image inputted by the input unit;
a model part generation unit which generates a model part corresponding to the first subject person, based on the part extracted by the part extraction unit; and
an exaggeration unit which relatively exaggerates an attribute of the model part depending on a difference between an attribute included in the image other than an attribute of the first subject person, and the attribute of the first subject person.

2. The image processing apparatus according to claim 1, wherein:
the part extraction unit extracts a part of a second subject person that is included in the image and is different from the first subject person, and
the exaggeration unit relatively exaggerates an attribute of the part of the first subject person depending on a difference between an attribute of the part of the second subject person and the attribute of the part of the first subject person.

3. The image processing apparatus according to claim 1, wherein the exaggeration unit relatively exaggerates the attribute of the part of the first subject person depending on a difference between an attribute of a background included in the image and the attribute of the part of the first subject person.

4. The image processing apparatus according to claim 2, wherein the exaggeration unit relatively exaggerates the attribute of the part of the first subject person depending on a difference between an attribute of a background included in the image and the attribute of the part of the first subject person.

5. The image processing apparatus according to claim 1, further comprising:
a motion detection unit which detects a user's motion; and
a part adjustment unit which replaces or changes the part of the first subject person or the attribute of the part, based on the user's motion detected by the motion detection unit.

6. The image processing apparatus according to claim 4, further comprising:
a motion detection unit which detects a user's motion; and
a part adjustment unit which replaces or changes the part of the first subject person or the attribute of the part, based on the user's motion detected by the motion detection unit.

7. The image processing apparatus according to claim 1, wherein the attribute includes at least one of a shape, a color and a position.

8. The image processing apparatus according to claim 6, wherein the attribute includes at least one of a shape, a color and a position.

9. The image processing apparatus according to claim 1, further comprising:
a character generation unit which generates a character based on the model part of the first subject person.

10. The image processing apparatus according to claim 8, further comprising:
a character generation unit which generates a character based on the model part of the first subject person.

11. The image processing apparatus according to claim 1, wherein the model part generation unit changes a precision of the model part depending on a size of the first subject person.

12. The image processing apparatus according to claim 10, wherein the model part generation unit changes a precision of the model part depending on a size of the first subject person.

13. An image processing method which causes a computer to execute the steps of:
inputting an image;
extracting a part of a desired first subject person from the inputted image;
generating a model part corresponding to the first subject person, based on the extracted part; and
relatively exaggerating an attribute of the model part depending on a difference between an attribute included in the image other than an attribute of the first subject person, and the attribute of the first subject person.

14. An image processing program which causes a computer to execute an image processing method according to claim 13.

15. A recording medium which stores computer readable code of the image processing program according to claim 14.
